(19) United States
(12) Patent Application Publication
(10) Pub. No.: US 2004/0076333 A1
(43) Pub. Date: Apr. 22, 2004

(54) Adaptive interpolation filter system for motion compensated predictive video coding

(76) Inventors: Huipin Zhang, Milpitas, CA (US); Frank Bossen, San Jose, CA (US)

Correspondence Address: INDIANAPOLIS OFFICE 27879, BRINKS HOFER GILSON & LIONE, ONE INDIANA SQUARE, SUITE 1600, INDIANAPOLIS, IN, 46204-2033, US

(21) Appl. No.: 10/277,554

(22) Filed: Oct. 22, 2002

(51) Int. Cl. G06K 9/36; G06K 9/46

(52) U.S. Cl. 382/238; 382/239

(57) ABSTRACT

An adaptive interpolation filter system for searching to obtain an optimized interpolation filter that minimizes prediction error in a video codec includes an interpolation module and a discrete search space. A plurality of discrete interpolation filters are positioned in a three dimensional grid within the search space. The interpolation module may select a current minimum filter. Based on the current minimum filter, a search region within the search space that includes a plurality of candidate filters located adjacent to the current minimum filter may be identified. The interpolation module may interpolate a reference image signal with each of the candidate filters. The candidate filter resulting in the smallest prediction error may be identified as the current minimum filter and the search repeated until the prediction error is minimized.

### FIELD OF THE INVENTION

The present invention relates generally to video coding, and more particularly, to an adaptive interpolation filter system for motion compensated predictive video coding.

### BACKGROUND

Video codecs using compression techniques for encoding (compressing) and decoding (decompressing) video information are well known. Typically, video codecs are utilized when it is important to minimize the amount of video data transferred over a data link. Most state-of-the-art video codecs are based on motion compensated prediction with motion vectors of fractional pixel resolution. The precision of the fractional pixel resolution of motion vectors has been increasing in recent years. Fractional pixel resolution may be expressed in terms of ½ pixel resolution, ⅓ pixel resolution, ¼ pixel resolution, ⅙ pixel resolution, ⅛ pixel resolution, etc. For example, in the video coding standard MPEG-2, the motion vectors can be in half-pixel resolution (or precision). In the MPEG-4 version video coding standard, the resolution of the motion vectors can be even higher, i.e., in ¼-pixel resolution. Another technique known as Advanced Video Coding (AVC) allows 1/8-pixel resolution for the motion vectors.

The purpose of using fractional pixel resolution is to obtain more accuracy in the definition of image content displacement between frames of video data. An increase in the resolution of motion vectors typically provides a corresponding increase in the accuracy of prediction during encoding of the frames of video data. Accuracy increases in prediction may result in improved reconstructed video images as well as more efficient encoding/decoding (e.g. coding gain). Fractional pixels are interpolated to estimate the displacement of fractional resolution on the encoder side. In addition, fractional pixels may be interpolated to compensate for displacements of fractional resolution on the decoder side.

Frames in fractional pixel resolutions may be generated by low-pass filtering the original pixel-precision frame. Low pass filtering is utilized since in the frame-to-frame prediction process, low and medium frequency content is typically well suited for prediction, whereas high frequency content tends to be less predictable. The best fractional-pixel motion vector is generally determined by examining the fractional pixels around the full pixel specified by the motion vector in full resolution.

For example, one well known procedure for searching a motion vector of ⅛ resolution in AVC involves: 1) searching to find the best full-pixel vector; 2) checking the eight ½-pixel positions around the best full-pixel vector to find the best ½-pixel vector; 3) checking the eight ¼-pixel positions around the best ½-pixel vector to find the best ¼-pixel vector and; 4) checking the eight ⅛-pixel positions around the best ¼-pixel vector in order to find the best ⅛-pixel vector. Therefore, the accuracy of the motions between frames of video data is influenced by two factors: the accuracy of the motion vectors in full resolution and the interpolation scheme for generating the fractional pixels.

Interpolation of ½, ¼, etc. pixels typically involves the use of a low pass filter that is linear. Such filters may be designed with different coefficients and numbers of coefficients. One well-known type of filter is a fixed filter known as a binary filter that is uniformly applied to each pixel. More recently, a new technique known as adaptive interpolation filtering (AIF) has been applied to interpolate the various pixel resolutions. A description of AIF is provided in T. Wedi, Adaptive Interpolation Filter with Reduced Complexity, Joint Video Team of ISO/IEC MPEG and ITU-T VCEG—4^{th} meeting, Kagenfurt, Austria, July 2002. In general, AIF is based on filter coefficients that are adapted once per frame to non-stationary statistical properties (e.g. aliasing, motion) of video signals. The adapted coefficients are coded and transmitted as part of the frame.

Two existing numerical search methods utilized within the design of adaptive interpolation filtering are known as a variable metric method and a downhill simplex method. These numerical search methods are described in W. H. Press, S. A. Teukolsky, W. T. Verterling, B. P. Flannery, Numerical Recipes in C++—The Art of Scientific Computing, Cambridge University Press, 2002. Both of these numerical search methods may be used to find the best interpolation filter.

The variable metric method (also called quasi-Newton method) is a numerical gradient-based method that iteratively minimizes the prediction error associated with the interpolation filter. Each iteration calculates the prediction error with the current filter and produces a new filter for the next iteration.

The downhill simplex method is a non-gradient-based numerical search method that utilizes a predetermined geometric shape referred to as a simplex. The simplex is applied to a search space that includes a plurality of filters. For example, in a three dimensional search space, the simplex is defined as a tetrahedron. The simplex is then expanded, contracted, and reflected in a series of random steps in an effort to minimize prediction error. First, the points where the objective function (prediction error) is the highest (high point) and the lowest (low point) are found within the search space. The simplex may then be reflected around the high point in search of a better prediction error. If the prediction error is better in a direction from the high point, the simplex may be expanded in that direction. If it is found that the prediction error is worse than the second highest objective function, an intermediate point may be tried. If no improvement is found after a number of steps, the simplex is contracted, and started again.

One problem with the variable metric method and the downhill simplex method are the significant amounts of computations that must be performed to arrive at a solution. Not only are these computations demanding on the processor running such instructions, but they may also take significant amounts of time to execute. In addition, due to the random form of searching for an appropriate filter, the filter identified in the search may represent the best local minimum prediction error instead of the best global prediction error. In other words, due to the randomness of the search, the best filter with the best minimum prediction error may not be identified.

### SUMMARY

The present invention includes an adaptive interpolation filter system that may identify an optimal filter for a video codec based on minimization of prediction error. The optimal filter may be identified efficiently with significantly less computation complexity than with previously known methods. In addition, the adaptive interpolation filter system performs a directed and focusing search for an interpolation filter resulting in a minimized prediction error instead of a random search as in previously known methods.

The adaptive interpolation filter system includes a search space and an interpolation module capable of executing instructions to perform a heuristic search of the search space. The search space is a discrete three dimensional space that includes a plurality of interpolation filters positioned in a grid pattern in the search space. The interpolation module may select a current minimum filter from within the search space. From the current minimum filter, a search region may be identified in the search space that includes a plurality of adjacently located candidate filters. The term “candidate filter” refers to filters in the search region that may be used to determine a prediction error in an effort to identify filters that provide smaller prediction error than the current minimum filter. The interpolation module may perform trials with the candidate filters.

The trials may involve interpolating a reference image signal with each of a plurality of selected candidate filters to generate a predicted image signal. The predicted image signal may be compared to the current image signal to obtain the prediction error associated with each candidate filter. The candidate filter identified to have the smallest associated prediction error may be further identified as the current minimum filter and the search operation may be iteratively repeated until the prediction error is minimized below a prediction error threshold. When the prediction error is adequately minimized, the corresponding interpolation filter may be identified as the optimal filter and the frame may be coded.

An interesting feature of the adaptive interpolation filter system involves the candidate filters within the search region for which trials are performed. To further limit computational complexity, a search set may be identified within the search region. The search set may contain fewer candidate filters than are within the search region to lower the amount of searching performed. The reduction in candidate filters may be based on the shape of the search set, such as a cube or a skew cube shape. The cube or skew cube shape may be sized such that only adjacently located candidate filters that surround the current minimum filter may be included in the search set. The candidate filters may also be those filters that are contiguous with the current minimum filter. Additional candidate filters may be eliminated to further reduce the search set based on similarities in gain with the current minimum filter. Two example search sets are a ten neighbor search set and a six neighbor search set.

Another interesting feature of the adaptive interpolation filter system involves selection of the current minimum filter. The initial filter selected as the current minimum filter when a search begins may be either a default filter or the optimal filter from the previous frame. In addition to identifying the center of the search region, the initial filter may also specify the initial precision of search iterations to be performed.

Yet another interesting feature of the adaptive interpolation filter system involves the performance of the search. During the search, a precision threshold for deeper moves within the search space may efficiently identify the final precision of the optimal filter. In addition, a restart threshold for wider moves may prevent unnecessary trials. Further, lower moves to decrease the precision may be made to improve the search efficiency. Also, a prediction error threshold may further limit the extent of the search. The prediction error threshold may be the difference between the last two prediction errors identified in successive trials.

Still another interesting feature relates to the extent of the search performed to minimize the prediction error. An image in each frame may be divided into a plurality of macroblocks. Instead of determining the prediction error for all the macroblocks in a frame, a partial prediction error may be determined with the adaptive interpolation filter system. The partial prediction error determination involves classifying the macroblocks as smooth macroblocks and non-smooth macroblocks. Trials may then be performed to determine the prediction error based on only the non-smooth macroblocks.

Further objects and advantages of the present invention will be apparent from the following description, reference being made to the accompanying drawings wherein preferred embodiments of the present invention are clearly shown.

### BRIEF DESCRIPTION OF THE DRAWINGS

FIG. 1 is a block diagram of a video codec that includes an adaptive interpolation filter system.

FIG. 2 is a block diagram illustrating fractional pixel generation with the video codec of FIG. 1.

FIG. 3 is a process flow diagram depicting general operation of the adaptive interpolation filter system within the video codec illustrated in FIG. 1.

FIG. 4 is a more detailed block diagram of the adaptive interpolation filter system depicted in FIG. 1.

FIG. 5 is a portion of a search space illustrated generally in FIG. 4 that includes a cube shaped search set.

FIG. 6 is a portion of the search space illustrated generally in FIG. 4 that includes a skewed cube shaped search set.

FIG. 7 is a portion of the search space illustrated generally in FIG. 4 that depicts a ten member search and a six member search of a search set.

FIG. 8 is an example image being processed with the adaptive interpolation filter system of FIG. 1.

FIG. 9 is a flow diagram illustrating operation of the adaptive interpolation filter system.

FIG. 10 is a second portion of the flow diagram illustrated in FIG. 9.

FIG. 11 is a third portion of the flow diagram illustrated in FIG. 9.

FIG. 12 depicts graphs of test results from examples of performance testing of the adaptive interpolation filter system of FIG. 1.

FIG. 13 depicts graphs of additional test results from examples of performance testing of the adaptive interpolation filter system of FIG. 1.

### DETAILED DESCRIPTION

The present invention includes an adaptive interpolation filter system for obtaining an optimized interpolation filter for minimizing the predication error in a video codec. The adaptive interpolation filter system utilizes a heuristic search technique that increases coding efficiency and decreases computational complexity. The adaptive interpolation filter system identifies a search set within a search region and performs successive trials to identify the interpolation filter that produces the smallest prediction error. The number of candidate interpolation filters is reduced to those within the search region. Simple and accurate computations may be performed on the interpolation filters within the search set to identify the filter that minimizes prediction error.

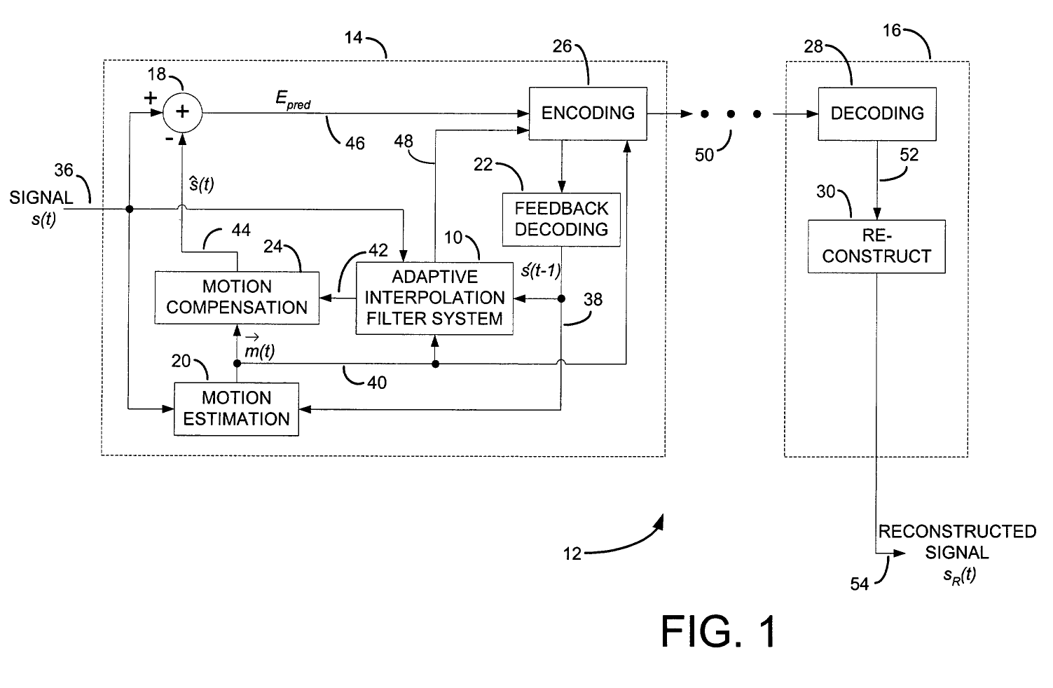

FIG. 1 is a block diagram depicting an adaptive interpolation filter system 10 within an example video codec 12. The video codec 12 includes an encoder 14 and a decoder 16. Within the encoder 14 is the adaptive interpolation filter system 10, a summer 18, a motion estimation module 20, a feedback decoding module 22, a motion compensation module 24 and an encoding module 26. The decoder 16 includes a decoding module 28 and a reconstruction module 30.

As hereinafter generally described, a current frame s(t) of an image signal to be coded may be predicted by motion compensated prediction. Prediction may be from a reference frame s′(t−1) of an image signal that was previously encoded and transmitted by the encoder 14. Based on the motion compensated prediction, a final prediction error ε_{pred} representative of the current frame s(t) may be determined, encoded and transmitted to the decoder 16. In addition, a motion vector \vec{m}(t) representative of the current frame s(t) may also be determined, encoded and transmitted to the decoder 16. The motion vector \vec{m}(t) may represent the displacement of the image signal within a block in the current frame s(t) from an image signal within the same block in the already transmitted reference frame s′(t−1).

During operation, the current frame s(t) (current image signal) may be provided as an input signal to the encoder 14 on a current frame line 36. The current frame s(t) may be provided to the adaptive interpolation filter system 10, the summer 18 and the motion estimation module 20. A previously encoded and transmitted frame of the image signal (reference image signal) may be provided as the reference frame s′(t−1). The reference frame s′(t−1) may be provided to the adaptive interpolation filter system 10 from the feedback decoding module 22 on a reference frame line 38. The reference frame s′(t−1) may also be provided to the motion estimation module 20.

The motion estimation module 20 may partition the current frame s(t) into blocks and assign a motion vector \vec{m}(t) to each block. The motion vectors \vec{m}(t) may have fractional pixel resolution, and therefore may refer to the position of the image signal within the reference frame s′(t−1). Estimation and compensation of the fractional pixel displacements in the reference frame s′(t−1) may be generated by interpolation with the adaptive interpolation filter system 10.

The motion vectors \vec{m}(t) may be provided to the adaptive interpolation system 10, the motion compensation prediction module 24 and the encoding module 26 on a displacement vector line 40. The adaptive interpolation filter system 10 may iteratively interpolate the reference frame with different interpolation filters and perform motion compensation with the motion vector \vec{m}(t) to create a series of different predicted images ŝ(t). Each of the different predicted images ŝ(t)may be compared to the image of the current frame s(t) to determine a prediction error ε_{pred}. The prediction error ε_{pred} from each filter may be used during the search for an optimal interpolation filter.

The term “optimal interpolation filter” or “optimal filter” refers to an interpolation filter that best minimizes the prediction error in the current frame s(t). Identifying the optimal interpolation filter may be based on achieving a control condition(s) such as determined threshold parameters, parameters from a previous frame(s) and/or any other criteria. Following interpolation with the optimal interpolation filter, the interpolated reference frame s′(t−1) may be provided to the motion compensation prediction module 24 on an interpolated reference frame line 42.

The motion compensation prediction module 24 may utilize the reference frame s′(t−1) that has been interpolated with the optimal filter and motion vectors \vec{m}(t) from the current frame s(t) to perform motion compensated prediction. The result of the motion compensated prediction is a final predicted image ŝ(t). The final predicted image ŝ(t) is provided to the summer 18 on a resulting image line 44 and subtracted from the image signal of the current frame s(t). A final resulting prediction error ε_{pred} is provided by the summer 18 to the encoding module 26 on a prediction error line 46. In addition, the optimal interpolation filter is provided to the encoder 26 on an optimal filter line 48. The encoding module 26 may encode the optimal interpolation filter, the final prediction error ε_{pred} and the motion vector \vec{m}(t) to represent a portion of the current frame s(t). The final prediction error ε_{pred} and the motion vector \vec{m}(t) may be transmitted to the decoder 16 over a data link 50. The data link 50 may include wireline and/or wireless communication medium, networks, etc.

The decoder 16 may perform decoding of the current frame s(t) with the optimal filter, the final prediction error ε_{pred} and the motion vector \vec{m}(t) utilizing the decoding module 28. It should be realized that the decoding process is similar to the previously discussed encoding process and is therefore not repeated. Following decoding with the decoding module 28, the decoded current frame s(t) is forwarded to the reconstruction module 30 on a decoded frame line 52 The reconstruction module 30 may use the decoded current frame s(t) to generate a reconstructed signal that is the reconstructed current frame sᵣ(t) on a reconstructed line 54. The reconstructed current frame sᵣ(t) may be representative of the current frame s(t) of the image signal. Once reconstructed, the image within the reconstructed current frame sᵣ(t) may be displayed.

Interpolation with the adaptive interpolation filter system 10 of the reference frame s′(t−1) allows for the generation of fractional pixel motion vectors. In advance video coding (AVC) there have been many approaches regarding the resolution of the motion vectors. Over the years, different pixel precision of ⅓-pixel, ¼-pixel, ⅙-pixel, and ⅛-pixel and interpolation of ¼-pixel and ⅛-pixel resolutions have been adopted and implemented.

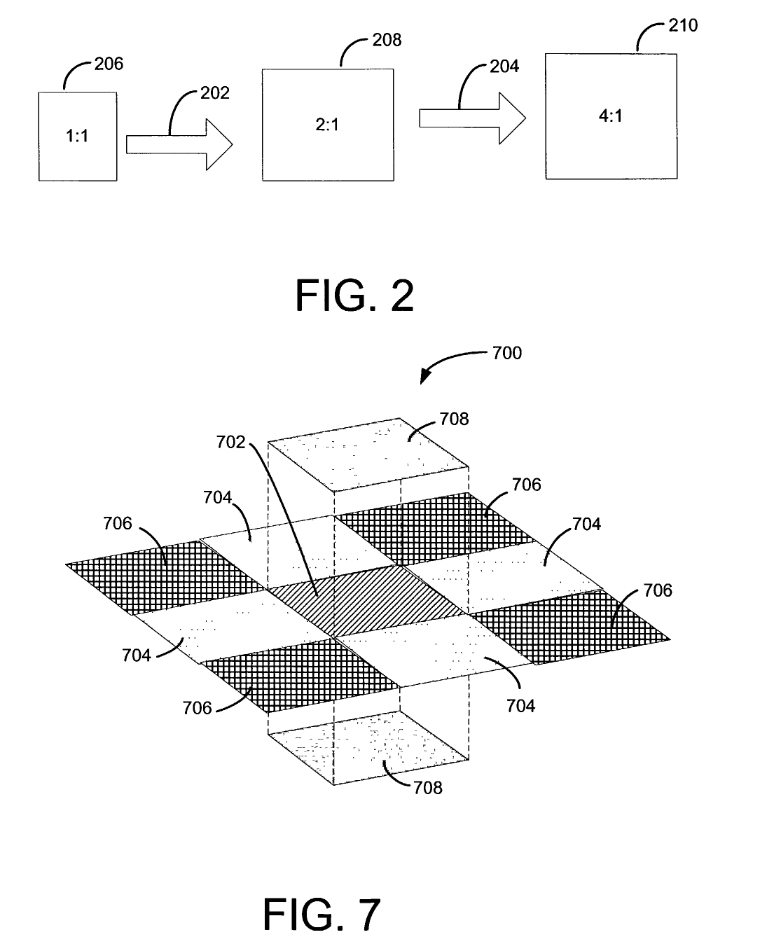

A key component of interpolation by filtering is the design of the interpolation. In general, the interpolation may be designed as invariant or adaptive interpolation. Invariant interpolation involves fixed interpolation filters with fixed filter coefficients that neither vary within a frame or within a sequence of frames. For example, FIG. 2 is a block diagram illustrating the generation of fractional pixels of ¼-pixel resolution. Generation of fractional pixels with invariant interpolation may be based on a well-known interpolation scheme where filtering with a first interpolation filter 202 and a second interpolation filter 204 is utilized to generate fractional pixels of ¼-pixel resolution. A full pixel vector (1:1) 206 may be filtered with the first interpolation filter 202 to generate a ½ pixel vector (2:1) 208. Subsequently, the ½ pixel vector 208 may be filtered with the second interpolation filter 204 to generate a ¼ pixel vector 210.

Example low pass interpolation filters that may be used alone or in combination for the first and second filters 202 and 204 are:

2-tap:W₂=[1·1]/2 (Equation 1)

4-tap:W₄=[−1·5·5·−1]/8 (Equation 2)

6-tap:W₆=[1·−5·20·20·−5·1]/32 (Equation 3)

8-tap:W₈=[−1·3·−6·20·20·−6·3·1]/32 (Equation 4)

Each of the interpolation filters (Eq. 1-4) include symmetric filter coefficients or parameters. For generation of frames of ¼-pixel precision with fixed interpolation filters it is well known that the combination of 6-tap:W₆ (Eq. 3) for the first interpolation filter 202, and 2-tap:W₂ (Eq. 2) for the second interpolation filter 204 are good choices. In other examples, any number of interpolation filters may be used depending on the desired pixel resolution. For example, for ⅛ pixel resolution three interpolation filters may be used.

Adaptive Interpolation Filtering (AIF) on the other hand, is a well-known technique for interpolation filtering based on filter coefficients that may be adapted once or more per frame to the non-stationary statistical properties (e.g. aliasing, motion) of the video signals. With AIF, one or more interpolation filters may be adaptive. For example, instead of the first interpolation filter 202 being a fixed filter with 6-tap:W₆ (Eq. 3) coefficients as in the previous example, the first interpolation filter 202 may be an adaptive interpolation filter capable of selective applying the filter coefficients from any of Eq. 1 through 4.

Similar to the previous example, the first interpolation filter 202 may be used to interpolate a full pixel to a half-pixel. The coefficients of the first interpolation filter 202 selected for use in the interpolation may be coded and transmitted to the decoder 16 as part of the current frame. As is well known, adaptive interpolation filters may have a fixed number of taps (or filters) and corresponding adaptive filter coefficients. The taps may be selectively utilized to interpolate motion vectors in the reference frames. The determination of which tap and therefore which filter coefficients are utilized to interpolate motion vectors may involve an optimization solution that produces an optimal prediction gain for motion compensation.

In this example, the second interpolation filter 204 may remain a fixed filter, such as with the 2-tap:W₂ (Eq. 2). In other examples, however, all of the interpolation filters may be adaptive interpolation filters. In still other examples, any combination of adaptive and fixed interpolation filters may be utilized.

In the presently preferred embodiments, the adaptive interpolation filter system 10 operates with adaptive interpolation filtering.

The design of AIF for a given frame can be formulated as an optimization equation for minimizing the overall prediction error between macroblocks in the frame. The term “blocks” or “macroblocks” refers to division of the pixels (or fractional pixels) within a frame into smaller more manageable groups. For example, each block in a frame may be a sixteen by sixteen group of pixels.

The optimization equation may be described as:

$${f}_{opt} = arg {min}_{f} {ϵ}_{pred} , \qquad ( Equation 5 )$$

where ε_{pred} is the prediction error, and fₒₚₜ is the optimal filter (tap) for the first interpolation filter 202 for the given frame. Note that the optimal filter fₒₚₜ may be optimal in the sense that for fractional pixel generation, the corresponding prediction error ε_{pred} is minimized. The optimal filter fₒₚₜ, however, may not necessarily be optimal in terms of the compression gain of the frame.

The prediction error ε_{pred} may be generally defined as a Sum of Absolute Difference (SAD), Sum of Squared Difference (SSD) or Sum of Absolute Transformed Difference (SATD) between the original pixel and the prediction pixel in a frame. Since the predicted image ŝ(t) for a frame may be determined by the motion vectors and the fractional pixel interpolation scheme, the prediction error ε_{pred} may similarly be a function of motion vectors and interpolation filters.

The optimization equation (Eq. 5) may be difficult to solve since determination of the prediction error ε_{pred} (the objective function of the optimization problem) depends on multiple variables. A practical way to solve multi-variable optimization problems is to convert them into subsequent sub-optimal problems that are easy to solve. This divide-and-conquer strategy may be used in simplifying Eq. 5 by separating the search of motion vectors from the optimization problem. In other words, fixed motion vectors may be used in the optimization problem. The fixed motion vectors may be determined either by performing a motion vector search prior to solving the optimization problem or by iteration. Accordingly, determination of the prediction error ε_{pred} may depend only on the filter selected for the first interpolation filter 202.

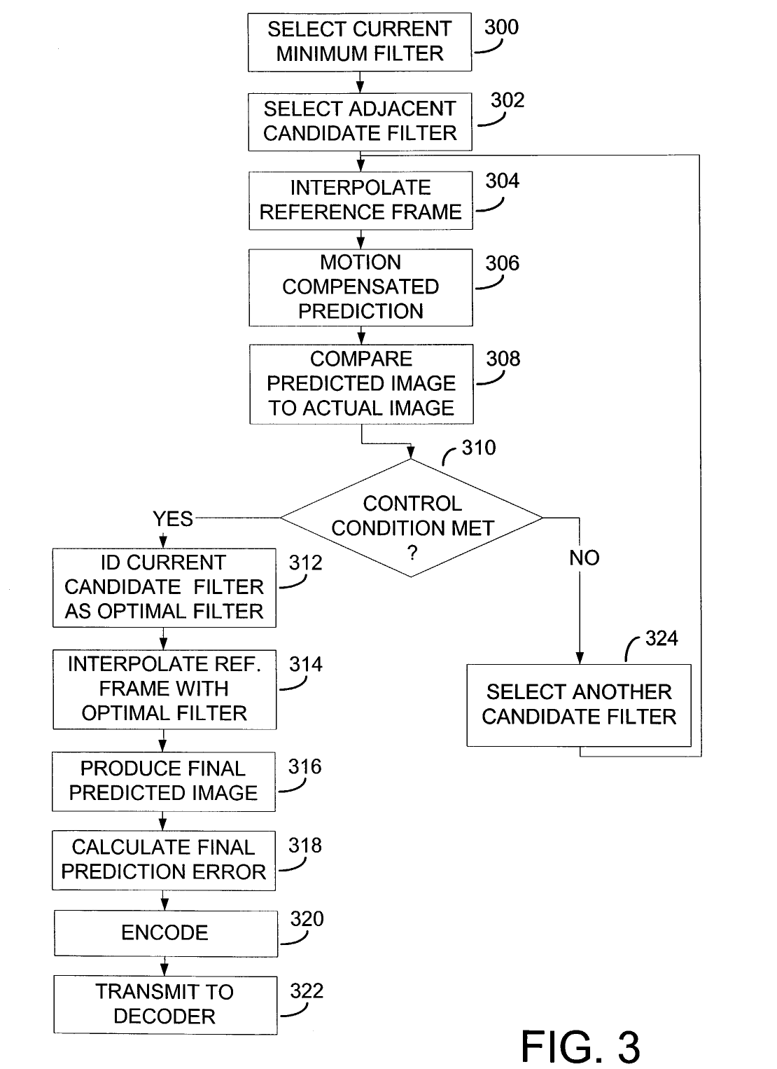

FIG. 3 is a high level process flow diagram generally illustrating the framework for implementing the solution to Eq. 5 and performing motion compensated predictive coding in the video codec 12 depicted in FIG. 2. The operation begins at block 300 when an initial filter that is a current minimum filter is selected by the adaptive interpolation filter system 10. The currently selected interpolation filter (e.g. filter coefficients) may be referred to as a current minimum filter, and the first current minimum filter selected may be referred to as an initial filter. As used herein, the term “current minimum filter” refers to an identifier used to identify an interpolation filter as the center of a search for candidate interpolation filters capable of providing a minimum prediction error. At block 302 one of a plurality of candidate filters adjacent to the current minimum filter may be selected. The reference frame s′(t−1) may be interpolated with the selected candidate filter to obtain the desired pixel resolution of the reference frame image at block 304.

At block 306, motion compensated prediction is performed by the adaptive interpolation filter system 10 (FIG. 1) using the interpolated reference frame image and the motion vector \vec{m}(t). A resulting predicted image ŝ(t) is compared to the image of the current frame s(t) at block 308 to determine the prediction error (ε_{pred}). At block 310, based on the prediction error (ε_{pred}) it is determined if the control condition(s) such as determined threshold parameters, parameters from a previous frame(s), etc. have been met.

If the control condition(s) has been met, the candidate filter is identified as the optimal filter at block 312. At block 314, the reference frame s′(t−1) is interpolated with the optimal filter by the adaptive interpolation filter system 10. The motion compensation module 24 utilizes the interpolated reference frame s′(t−1) and the motion vector \vec{m}(t) to calculate a final predicted image ŝ(t) at block 316. At block 318, the final prediction error (ε_{pred}) is determined from the current image and the predicted image ŝ(t). The optimal filter, the motion vector \vec{m}(t) and the final prediction error (ε_{pred}) is encoded by the encoder 26 at block 320. At block 322, the encoded information is transmitted to the decoder 16.

If at block 310, the control condition is not met, the current candidate filter is replaced with another candidate filter adjacent to the current minimum filter by the adaptive interpolation filter system 10 at block 324. The operation then returns to block 304 to again determine the predicted image ŝ(t), the corresponding prediction error (ε_{pred}) and whether the control condition(s) has been met. As discussed later, in addition to iteratively replacing the candidate filters, the adaptive interpolation filter system 10 may also iteratively change the current minimum filter thereby adjusting the center of the search among adjacently located candidate filters.

With the framework described in FIG. 3 and the example illustrated in FIG. 2, the prediction error (ε_{pred}) may be a function of the first interpolation filter 202, given that an interpolation scheme, subsequent filtering or invariant interpolation, is specified. In other known frameworks, an invariant filter with 6 tap:W6 (Eq. 3) filter coefficients has been adopted and is generally efficient. Therefore, a known assumption of the form of the first interpolation filter 202 (f) when using adaptive interpolation filtering is:

f=[a₂·a₁·a₀·a₀·a₁·a₂]^{t}, Equation 6

where f has up to six taps and is symmetric. Accordingly, there are three parameters in the simplified optimization problem:

$${h}_{opt} = arg {min}_{h} {ϵ}_{pred} ( h ) , \qquad ( Equation 7 )$$

where h=[a₀·a₁·a₂]^{t} is a parameter vector representing coefficients in an interpolation filter, hₒₚₜ is the optimal parameter vector and the prediction error ε_{pred} (h) is a function of the parameter vector h.

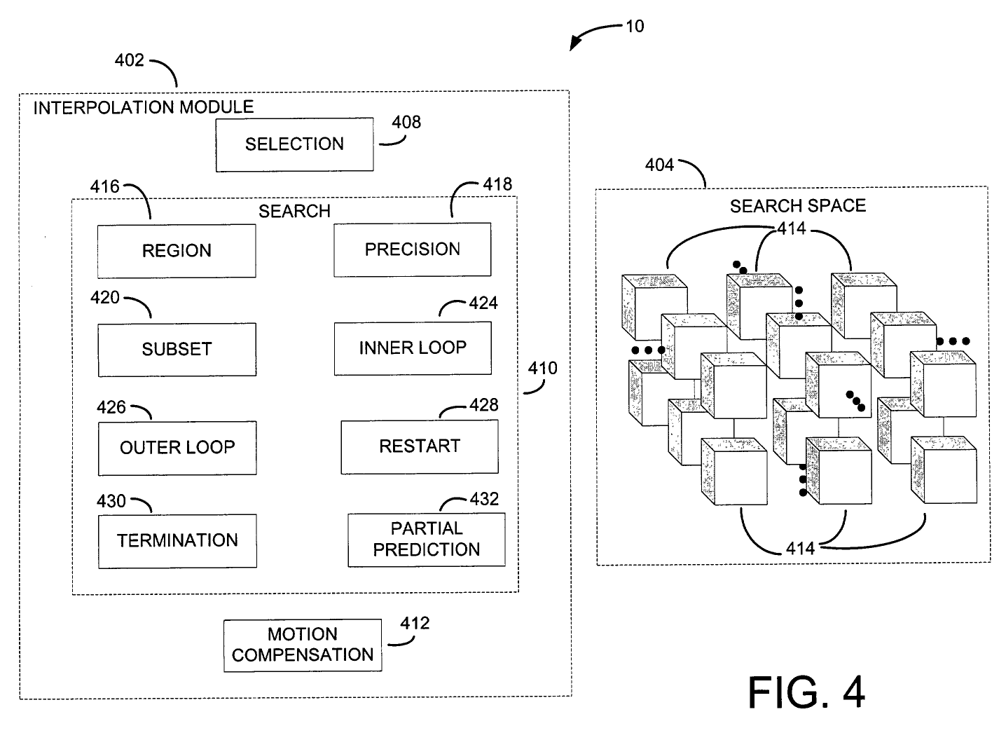

FIG. 4 is a more detailed block diagram of the adaptive interpolation filter system 10. The adaptive interpolation filter system 10 includes an interpolation module 402 and a search space 404. The interpolation module 402 may execute the heuristic search technique on the search space 404 to achieve minimum prediction error. In general, the interpolation module 402 may search for a minimum prediction error by a sequence of trials. Trials may be successively performed by the interpolation module 402 in a direction of improvement within the search space 404 until an optimum solution is reached (e.g. minimized prediction error). The interpolation module 402 may utilize the adaptive interpolating framework (AIF). Compared to known AIF design methods, such as the variable metric method and the downhill simplex method, the heuristic search technique performed by the interpolation module 402 is more numerically efficient.

The interpolation module 402 may include a plurality of instructions stored in a memory device such as a semiconductor memory, a magnetic memory, an optical memory or any other form or data storage mechanism. The memory device may be part of the adaptive interpolation filter system 10, the video codec 12 or may be a separate memory device accessible with the video codec 12. Groups of associated instructions performing functions within the interpolation module 402 may be described in terms of components. The illustrated interpolation module 402 includes a selection component 408, a search component 410 and a motion compensation component 412. In other examples greater or fewer numbers of components may be utilized to illustrate the functionality of instructions within the interpolation module 402.

The instructions within each of the components stored in the memory device may be executed to perform the heuristic search technique. The heuristic search technique performed with the interpolation module 402 involves an exclusive search for an optimal interpolation filter that may provide the lowest prediction error.

Instructions within the selection component 408 may be executed to select an initial interpolation filter to be the current minimum filter when a search begins. Instructions within the search component 410 may also be executed to perform successive searches to identify interpolation filters resulting in lower prediction error. Instructions within the motion compensation component 412 may be executed during these searches to calculate different predicted images and resulting prediction errors based on the different interpolation filters identified during the search. The instructions in the selection component 408 may update the current minimum filter to be interpolation filters identified during the search that result in a lower prediction error. Searches with the search component 410 may be performed in the search space 404.

The search space 404 includes a plurality of interpolation filters 414. As used herein, the terms “interpolation filter” and “filter” are used interchangeably to identify a series of coefficients that may be utilized to interpolate reference frames. The interpolation filters 414 may be considered as positioned in a three-dimensional grid pattern within the search space 404 as illustrated. The search space 404 may be a discrete space that may also be referred to as a filter space. Data representative of the search space 404 and the interpolation filters 414 therein may similar be stored in a memory device. Each of the interpolation filters 414 represents a point in the grid and includes discrete filter coefficients. Filter coefficients associated with each of the interpolation filters 414 in the discrete search space 404 may be represented by integers forming a vector. An example optimal interpolation filter that minimizes prediction error may be represented by the vector (α):

α=[α₀·α₁·α₂]^{t}/α₃; Equation 8

where the α₁′s are integers and “/” represents division of numbers to achieve a precision of the integers in each vector within the search space.

The search space 404 may be populated with discrete filters 414 based on the integer values (α₀·α₁·α₂) of each filter 414. The integer values (α₀·α₁·α₂) of each filter 414 may describe respective x, y, z coordinates for mapping of the individually distinct filters 414 within the search space 404. Thus, a filter 414 may be positioned at the origin (0, 0, 0) of the search space 404. In addition, based on corresponding integer values, a plurality of other discrete filters 414 may be positioned at points throughout the grid formed in the three dimensional search space 404. The illustrated search space 404 depicts only a limited number of filters 414, however, an infinite number of discrete filters in the search space are possible. Due to the relationship between geometric position and the filter coefficients, the filters 414 may be logically positioned in the search space 404 such that the filter coefficients of adjacently located discrete filters 414 are substantially similar.

As should be recognized, the optimal interpolation filter obtained by searching the search space 404 with the search component 410 is actually a quantized optimal filter whose precision is determined by the search space 404. The integer α₃ of Eq. 8 may signify the precision of the search space 404. An interpolation filter 414 represented by two vectors, such as α=[40·−10·2]^{t}/64 and β=[80·−20·4]^{t}/128 may therefore be in search spaces 404 of different precisions, however the vectors may each represent the same interpolation filter 414. Therefore, the precision of the optimal interpolation filter is determined by the precision of the search space 404. The finer the grid of the search space 404, the finer the filter coefficients may be quantized.

Instructions representing the functionality within the illustrated search component 410 may be further identified with components that include a region component 416, a precision component 418, a subset component 420, an inner loop component 424, an outer loop component 426, a restart component 428, a termination component 430 and a partial prediction component 432.

Instructions within the region component 416 may identify a search region within the search space 404. The search region may be a determined group of interpolation filters 414 within the three-dimensional grid pattern of the search space 404. By searching the interpolation filters 414 within the search region identified by the region component 416, the search component 410 may identify an optimal interpolation filter by exclusively examining interpolation filters 414 in the search region. The interpolation filter 414 producing the smallest prediction error in the search region may be identified as the optimal interpolation filter by the search component 410. As previously described, the calculation of the prediction error corresponding to an interpolation filter 414 by the motion compensation component 412 in the search space 404 is based on interpolation of the reference frame with an interpolation filter 414.

An optimal interpolation filter with finer quantization may be obtained with the searching component 410 by searching interpolation filters 414 in the search space with higher precision. The precision of the search space 404 may be adjusted with the precision component 418. The expansion of the interpolation filters 414 in the search space 404 to a higher precision may be achieved by, for example, doubling the filter coefficients. Therefore, a search for an optimal interpolation filter 414 may be performed iteratively by the searching component 410, from a search space of a lower precision to a search space 404 of higher precision until an objective such as a determined precision, a threshold prediction error or any other parameter is achieved. Another view of this technique is that the optimal interpolation filter 414 is progressively quantized to generate optimal filters of various precisions. From the above description, it can be seen that the accuracy of an optimal interpolation filter may be determined by the search region identified and the precision of the search space 404.

As used herein, the term “search region” refers to a set of filters surrounding a specified filter that is the current minimum filter. The search region is generally characterized by its center (e.g. the current minimum filter), its search ranges of filter coefficients within the candidate filters and its shape. The shape of search region formed by the candidate interpolation filters in the three dimensional search space 404 is preferably a cube, however, search regions of other shapes, such as, for example, a sphere, etc. are also possible. An example search region Ω with a center c=[c₀·c₁·c₂]^{t} and search ranges of [−4,4]×[−2,2]×[−1,1] may be a cube described by:

Ω={[α₀·α₁·α₂]^{t}: α₀ε[c₀−4, c₀+4], α₁ε[c₁−2, c₁+2], α₂ε[c₂−1, c₂+1]} Equation 9

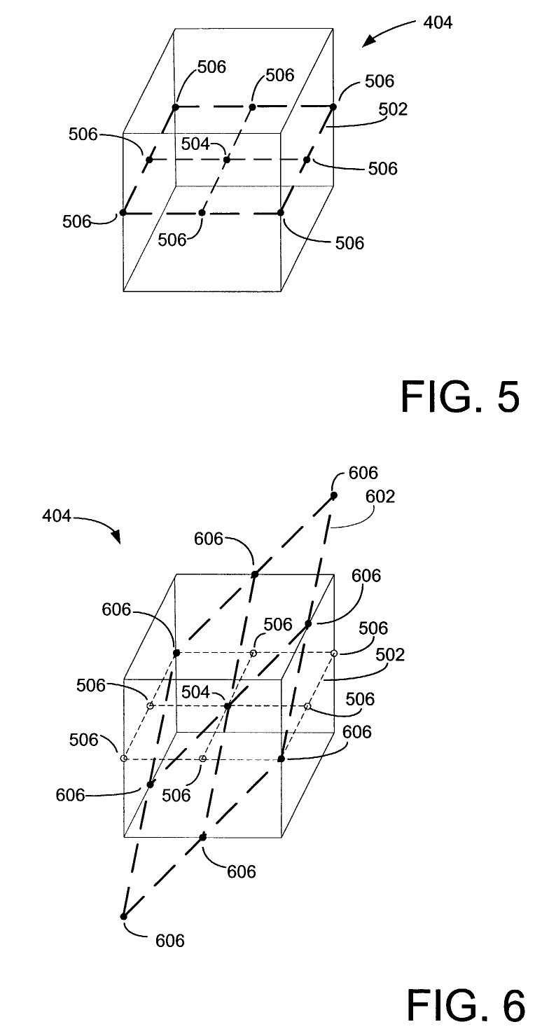

FIG. 5 is an example of a cube shaped search region 502 within a portion of the search space 404 where a current minimum filter 504 is surrounded by a plurality of adjacently positioned candidate filters 506. In the illustrated search region 502, only a single plane containing a limited number of candidate search filters 506 is illustrated for purposes of clarity. It should be realized however, that the complete cube shaped search region 502 may include at least three planes containing any number of candidate filters that are positioned adjacent to the current minimum filter 504.

In another example, the search region (Ω) may be a skew cube described in the three dimensional search space 404 by:

Ω={[α₀·α₁·α₂]^{t}: α₀ε[c₀−4, c₀+4], α₁ε[c₁−2, c₁+2], α₀+α₁α₂ε[c₀c₁+c₂−1, c₀+c₁+c₂+1]} Equation 10

FIG. 6 is an example of a skewed cube search region 602 within a portion of the search space 404 where the current minimum filter 504 is surrounded by a plurality of adjacently positioned candidate filters 606. Similar to FIG. 5, only a single skewed plane containing candidate search filters 606 is illustrated for purposes of clarity. It should be realized however, that the complete skewed cube shaped search region 602 may include at least three planes containing any number of candidate filters 606 that are positioned adjacent to the current minimum filter 504. The cube shaped search region 502 and associated candidate filters 506 of FIG. 5 are also depicted in FIG. 6 to further illustrate the shape of the skewed cube search region 602. The shape of the search region (Ω) may be determined by the region component 416.

Referring again to FIG. 4, the precision of the search region (Ω) may be selected by the precision component 418 based on the integer α₃ of Eq. 8, which may be values such as 32, 64, 128, etc. For example, for a search point α=[α₀·α₁·α₂]^{t} in the search region, the real value of the corresponding denominator (α₃) may provide the precision (see Eq. 8). With appropriate search regions (a good center and wide search ranges) selected by the region component 416, and appropriate filter precision (both initial precision and final precision) selected by the precision module 418, searching with the search component 410 may deliver an optimal interpolation filter with good accuracy.

To further simplify searching with the search component 410, the number of filter candidates in a search and therefore the amount of computations in examining a given filter may be reduced with instructions in the subset component 420. The reduction in candidate filters within the search region may be based on the position of the filter candidates relative to the current minimum filter. Accordingly, only a search set containing candidate interpolation filters representing a subset within the search region may be examined. Within this search set, a dynamic search may be performed by the search component 410 that corresponds to a sequence of trials. The trials may be successively performed in a direction of improvement until the optimal filter is reached. In addition, the search set may be dynamically redefined by the subset component 420 based on the trials.

For example, in a successive search with a current minimum filter of c=[c₀·c₁·c₂]^{t} selected by the selection component 408, the search set may include only contiguously located interpolation filters within the search space 404. The contiguously located filters may be direct neighbors of the current minimum filter. The search set may be a cube (FIG. 5) formed by the current minimum filter and adjacently located filters in a search set (Ξ) that is similar to Eq. 9 and described as:

Ξ={[α₀·α₁·α₂]^{t}: α₀ε[c₀−1, c₀+1], α₁ε[c₁−1, c₁+1], α₂ε[c₂−1, c₂+1]}, Equation 11

which may be the smallest cube around the current minimum filter (c).

An even more efficient search set may be designed by the subset component 420 in the form of a skew cube (FIG. 6). The skew cube may be the smallest skew cube that may be formed around the current minimum filter. Similar to Eq. 10, the search set (Ξ) may be described as:

Ω={[α₀·α₁·α₂]^{t}: α₀ε[c₀−1, c₀+1], α₁ε[c₁−1, c₁+1], α₀+α₁+α₂ε[c₀+c₁+c₂−1, c₀+c₁+c₂+1]}, Equation 12

where the gains of the filters within the skew cube may vary slightly due to occupying different gain planes, as described later. Candidate filters in this search set may be located on three parallel planes described by:

α₀+α₁+α₂=∇, Equation 13

where constant ∇ represents c₀+c₁+c₂−1, c₀+c₁+c₂ or c₀+c₁+c₂+1. As discussed later, candidate filters on each of the three planes may maintain a similar gain. Accordingly, these planes may be referred to as equal-gain planes.

Performance testing and other simulations have indicated that with a search set (Ξ)defined as a cube (FIG. 5) or a skew cube (FIG. 6), the search component 410 performs relatively well, however, a skew cube search set was identified as performing better than a cube search set. With these types of search sets (Ξ), there are twenty six interpolation filters 414 surrounding the current minimum filter in the three dimensional search space 404. Trials to determine the minimum prediction error may be performed by the search component 410 and the motion compensation component 412 with each candidate filter. Up to ⅔ of the trials may be performed with filters in the search set having a gain different from the gain of the current minimum filter.

The gains of the filters in the cube may vary significant amounts from the current minimum filter (c) at the center of the search region. As known in the art, the sum of the impulse response of the filter may be described as 2(α₀+α₁+α₂). The impulse response may characterize the gain of a filter. The gain may therefore be related to the geometric position of the discrete filters in the search space 404. The absolute difference of the sum of the impulse responses of the candidate filters in the search set (Ξ) from that of the current minimum filter may be, for example, up to six.

An efficient way to further reduce the size of the search set and therefore reduce computational resources is to exclude from the search set those candidate filters that have gains significantly different from the current minimum filter. A complete exclusion of such filters may however degrade the performance of the heuristic search technique. This may especially be the case where the video signal has a fading transition.

A compromise search involves selectively creating a search set with fewer candidate filters to further decrease the computational resources utilized during the search. The selection of candidate filters for the search set by the subset component 420 may be based on the physical location of each of the candidate filters in the search space 404 with respect to the current minimum filter.

To avoid large differences in filter gains that may result in filters that perform distinctly, the search set may be modified by instructions in the subset component 420. The search set may be modified to consist of candidate filters that are similar to the current minimum filter in terms of performance, rather than just in terms of geometric position (adjacently positioned) within the search space 404. Accordingly, candidate filters may be selected for the search set based on gains that are similar to the gain of the current minimum filter. Therefore, some of the contiguously positioned interpolation filters may not be included in the search set to further improve calculation efficiency.

In one alternative, the search set may include ten candidate filters in three groups that may be referred to as a “ten neighbor search.” The ten candidate filters may be contiguous neighbors with the current minimum filter. Another alternative may be referred to as a “six neighbor search” that includes six candidate filters in two groups that are contiguous neighbors. In still other alternatives, fewer or greater numbers of candidate filters may be included in the search set by the subset component 420.

FIG. 7 is a perspective view of a search set 700 in a portion of a three dimensional search space. The illustrated search set 700 includes a current minimum filter 702 selected by the selection component 408 (FIG. 4). In addition, the search set 700 includes a plurality of contiguous neighbor candidate interpolation filters within a first group 704, a second group 706 and a third group 708. It should be understood that there may be additional surrounding filters that are not illustrated. It should be further understood that the search set may be a cube shaped search set (Eq. 11) or a skewed cube shape search set (Eq. 12).

Both the first group 704 and the second group 706 may include four contiguous neighbor filters positioned to surround the current minimum filter 702. The first and second groups 704 and 706 may be positioned beside the current minimum filter 702 to indicate that each of the candidate filters in these groups have a gain that is similar to the current minimum filter 702. In other words, the filters positioned beside the current minimum filter 702 in the search space reside in the same gain plane. The third group 508 may include two contiguous neighbor candidate filters that are positioned above and below the current minimum filter 502. The above and below positioning of the candidate filters in the third group 508 may indicate that one filter includes a stronger gain than the current minimum filter 502 and the other filter includes a weaker gain. In other words, the candidate filters in the third group 508 may each be within different gain planes.

The integers within the contiguously positioned candidate filters may describe the geometric position of the candidate filters with respect to the current minimum filter 502. For example, in a skewed cube search set, where the current minimum filter 502 is described as c₀·c₁·c₂, the four candidate filters within the first group 504 may be described as:

[c₀+1·c₁·c₂−1]

[c₀−1·c₁·c₂+1]

[c₀·c₁+1·c₂−1]

[c₀·c₁−1·c₂+1]; Equation 14

the candidate filters within the second group 506 may be described as:

[c₀+1·c₁+1·c₂−2]

[c₀+1·c₁−1·c₂]

[c₀−1·c₁+1·c₂]

[c₀−1·c₁−1·c₂+2]; Equation15

and the candidate filters within the third group 508 may be described by:

[c₀·c₁·c₂+1]

[c₀·c₁·c₂−1] Equation 16

The ten neighbor search by the search component 410 (FIG. 4) may be selected by instructions in the subset component 420 (FIG. 4) to include the first group 504, the second group 506 and the third group 508. The search component 410 may successively search the groups within one or more ten neighbor searches and utilize the motion compensation component 412 (FIG. 4) to determine a minimum prediction error as previously discussed. Typically, during successive ten neighbor searches, although there are 10 candidate filters in each of the search sets, there may be less than 10 trials performed since part of the trials have already been performed during previous ten neighbor searches. Depending on which of the groups the current minimum filter 502 is from, only five, seven or nine trials may be performed to examine the current ten neighbor search. Ten trials may be performed either at the beginning of the search process or at the beginning of a search process in a search space of higher precision.

The six neighbor search may be selected by instructions in the subset component 420 (FIG. 4) to include the first group 504 and the third group 508. The search component 410 and the motion compensation component 412 (FIG. 4) may similarly search the groups within one or more six neighbor search sets. Since the number of trials is six or less in each successive search set, the computational resources are lower than in the ten neighbor search and the search is therefore more efficient. The performance of the six neighbor search in identifying a minimum prediction error may be almost similar to the performance of the ten neighbor search. Overall, the ten neighbor and six neighbor searches both provide a simplified search set that is not only efficient, but also accurate within the heuristic search technique.

As previously discussed, the search component 410 may perform successive trials in search sets. The search sets may be dynamically created during the search as a function of iteratively identifying current minimum filters from the trials in a previous search set.

There may be two iterations in the successive trial process by the search component 210 to dynamically create a new search set. Referring again to FIG. 4, a first iteration may be performed with instructions in the inner loop component 424 and a second iteration may be performed with instructions in the outer loop component 426. Instructions in the inner loop component 424 may control the search region of candidate filters of similar precision, while iterations of the outer loop component 426 may control the precision of the candidate filters.

In the inner loop component 424, the search set may be dynamically expanded. Dynamic expansion of the search set may involve including new filters in successive search sets. During a search, when a new minimum prediction error is identified by trials, the corresponding candidate filter may be designated as the current minimum filter by the selection component 408, and a new search region may be identified. The new search region may include contiguously positioned neighboring filters of the new current minimum filter. The subset component 420 may then identify a new search set within the new search region.

Trials may be successively performed with successive search sets in a direction of improvement until the optimum solution is reached. When an optimum solution is reached with the inner loop component 424, instructions in the outer loop component 426 may increase the precision of the current minimum filter with the precision component 418 by, for example, doubling the filter coefficients of the filters in the search space 404. Trials may then commence again in the search region with the inner loop component 424.

The inner and outer loop components 424 and 426 may be thought of as corresponding to a deeper search (outer loop component 426) and a wider search (inner loop component 424). The two types of searches may also be regarded as two types of moves in a numerical search, both contributing to the performance of the search component 410. In the numerical search context, the inner and outer loop components 424 and 426 may be described as a wider move and deeper move, respectively, where a deeper move is a “narrowing move.”

Deeper moves may be governed with a determined precision threshold. The precision threshold may be a determined maximum iteration, a threshold prediction error or any other parameter to avoid excessive iterations. The precision threshold may be set and monitored with instructions in the outer loop component 426.

The wider search, on the other hand, may remain substantially unrestricted except for when the restart threshold is enabled as described later. The wider search may remain substantially unrestricted since proceeding to a higher precision with the deeper search when a lower-precision minimum has not been reached may not result in identification of the optimum minimum prediction error. In other words, the search may proceed to a deeper level only if the search in the same level fails to further improve the minimum.

Performance of the search by the search component 410 is in a large part dependent on the filter initially selected with the selection component 408 to be the current minimum filter. When an inappropriate initial filter is selected for the current minimum filter by the selection component 408, it may take a significant period of time to reach a minimum prediction error. For example, if a filter with a significantly different gain or precision is selected more trials may be required to iteratively identify the filter that adequately minimizes prediction. In addition, only a local minimum that is close to the initial filter selected may be reached. An initial filter selected by the selection component 408 should therefore be positioned in the search space relatively close to the optimal filter that is ultimately identified by the search component 410. With a good initial filter selection, a smaller number of trials with the searching component 410 may be performed to identify the optimal interpolation filter.

Selection of the initial filter by the selection component 408 for the current minimum filter may be based on parameter analysis in the current frame, a default filter such as the 6-tap:W6 filter of Eq. 3, or any other filter which performs well for general video signals. Alternatively, for frames following a predicted frame of a video sequence, the optimal filter of the previous frame may be selected by the selection component 408 to be the initial filter. Since in natural video sequences signals of two consecutive temporal images have strong correlations, the optimal filter resulting from the search may be close to the optimal filter in the previous frame. Accordingly, selecting the optimal filter from the previous frame as the initial filter for the current minimum filter may improve the computational efficiency of the search by the search component 410.

It is also possible that selection of an appropriate initial filter with an inappropriate precision setting may lead the search to a local minimum or result in a prolonged search, since the initial filter may automatically set the precision of the search space. If the initial filter has high precision, the search may be very efficient, but the search may end up with a local minimum. On the other hand, if the initial filter has a low precision, it may take a long time to reach the minimum. As such, the optimal filter of the previous frame may be normalized to a lower precision, such as the initial precision in the previous frame, a determined amount, one step below the final precision of the previous frame or any other level of precision. The precision may be lowered by the precision component 418 before searching with the searching component 410 begins in the current frame.

When a default filter is selected by the selection component 408 a precision modification of the search space with the precision component 418 may be performed. Performance testing has shown that a default filter with a precision modification experiences a significant increase in computational efficiency. For example, where the default filter is the 6-tap:W6 filter of Eq. 3, a known precision modification to enhance performance may be:

α=[160·−40·8]/256. Equation 17

Referring still to FIG. 4, instructions in the restart component 428 may be used during wider moves directed by the inner loop component 424 to further enhance the search by the search component 410. The restart component 428 may execute instructions to limit the search range for filters (number of wider moves) for a filter precision specified with the precision component 418. The restart component 428 may limit the number of wider moves based on reaching a restart threshold. The restart threshold may be determined based on dynamic parameters associated with the search. If the restart threshold is too large, a superfluous search may reduce performance. If on the other hand the restart threshold is too small, a local minimum may be identified by the search.

The restart component 428 may control the number of wider moves when the restart threshold is reached and the next move is still a wider move. In this instance, the restart component 428 may triggered a reduction in the precision of the search space 404 with the precision component 418. The reduction in precision may be accompanied by the subsequent reset to the initial filter for the current minimum filter with the selection component 408. Lower precision may be accomplished by, for example, dividing the current search space 404 by a factor of 2 with the precision component 418. In addition, the restart component 428 may direct modification of the coefficients in the current minimum filter. For example, the third coefficient of the initial filter may be modified to make the current minimum filter be on an equal-gain plane that is as close as possible to the equal-gain plane of the previous current minimum filter.

As such, the restart component 428 may be considered as a third move, a lower move, in addition to the wider move and the deeper move that may occur during a search with the search component 410. The restart component 428 may not only improve the robustness of the heuristic search technique, but also may improve the efficiency. Efficiency may be improved since the restart component 428 may replace additional wider moves with potentially more efficient lower moves. Further, the restart component 428 may alleviate to some extent the dependency of the efficiency and performance of the search on the selection of the initial filter for the current minimum filter.

Instructions within the termination component 430 may support a prediction error threshold. The prediction error threshold may be a determined value representative of a desired maximum difference between the prediction error of a candidate filter and the previously determined prediction error of the current minimum filter. Further searching with the search component 410 may be terminated by the termination component 430. Further searching may be terminated when a candidate filter is identified in a current frame that results in a difference between the prediction error of the current minimum filter and the prediction error of candidate filter that is at or below the prediction error threshold. In other words, when the incremental improvement in prediction error provided by the candidate filter falls below the prediction error threshold, further searching may be terminated.

Alternatively, the termination component 430 may allow the search for minimization of the prediction error to continue beyond the prediction error threshold based on other parameters. Further searching however, may not be economical unless further minimization of prediction error contributes to either bit savings or quality improvements. However, due to the nonlinearity resulting from the quantization of discrete cosine transform (DCT) coefficients and entropy coding, there exists an extent to which bit savings and/or quality improvement may have an almost random relationship with the prediction error. For this reason a determined prediction threshold is desirable to terminate the search for an optimal filter when an adequate filter is identified. The prediction error threshold of the termination component 430 may however alternatively be a determined number of search iterations, a desired bit savings, a level of encoding quality or any other parameter related to encoding a frame of a video signal.

The partial prediction component 432 may also be utilized during the search for the optimal filter within the search space 404. Instructions within the partial prediction component 432 may further improve the efficiency of the heuristic search through the use of partial prediction error in the search process. Partial prediction error refers to minimization of only part of the prediction error, not the overall prediction error. An adequate resulting prediction error may be obtained from the motion compensation component 412 based on the partial prediction error since the remaining part of the prediction error may not change significantly with different interpolation filters. Due to the lessened computational demand of determining only a partial prediction error, computational resources may be further maximized.

Determination of which partial prediction error should be calculated may be based on the smoothness of the regions within a frame. For example, if a portion of the current frame includes a wall or other non-moving object, the pixels in that portion of the frame may be very similar. Accordingly, inclusion of such smooth regions in the search for minimization of the prediction error may be avoided, since whichever smoothing filter is used for interpolation, the resulting prediction error may be very similar. Therefore, the search may be for a partial prediction error representative of the non-smooth regions in the frame.

The smoothness of regions in the current frame may be determined based on classification of each macroblock. The regions may be classified as either a smooth macroblock or a non-smooth macroblock by considering the activity in the macroblock. Consideration of the activity within a macroblock may be performed with one or more high pass filters. For example, a first high pass filter F₁ and a second high pass filter F₂ may be described as:

F₁=[1·−1]^{t} Equation 18

F₂=F₁^{t}. Equation 19

The first and second filters F₁ and F₂ may be applied vertically and horizontally, respectively, to the image to be coded to generate two filtered images.

The measure of activity in a macroblock may be the squared sum of the pixels in the original image and the two filtered image. The activity may be equivalent to the energy of the edges in the macroblock. Utilizing a determined activity threshold, macroblock activity that is lower than the activity threshold may be designated as smooth macroblocks and activity above the activity threshold may be designated as non-smooth macroblocks. Alternatively, another type of filtering may be used to identify smoothness, such as, Sobel filters, however, more computations may be required.

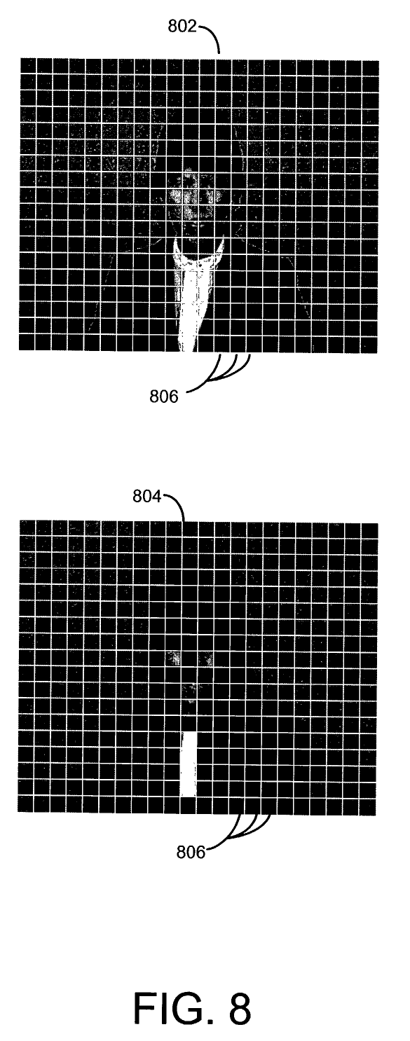

FIG. 8 is an example frame 802 and a high pass filtered frame 804 with macroblock classification. The filtered frame 804 is the same image as in the frame 802 but has been altered by filtering with at least one high pass filter to determine activity. Each of the frames is in a Clair sequence that includes a plurality of macroblocks 806 containing a plurality of pixels. In the illustrated high pass filtered frame 804, a portion of the macroblocks 806 (about 22% of the total) are illustrated as black. The black macroblocks 806 represent those macroblocks 806 classified as non-smooth macroblocks within the frame. Accordingly, the black macroblocks 806 may be used in minimization of the partial prediction error. The selective calculation of the prediction error based on the smoothness measure of the filters in a frame may improve efficiency for video sequences that include smooth images, such as smooth backgrounds.

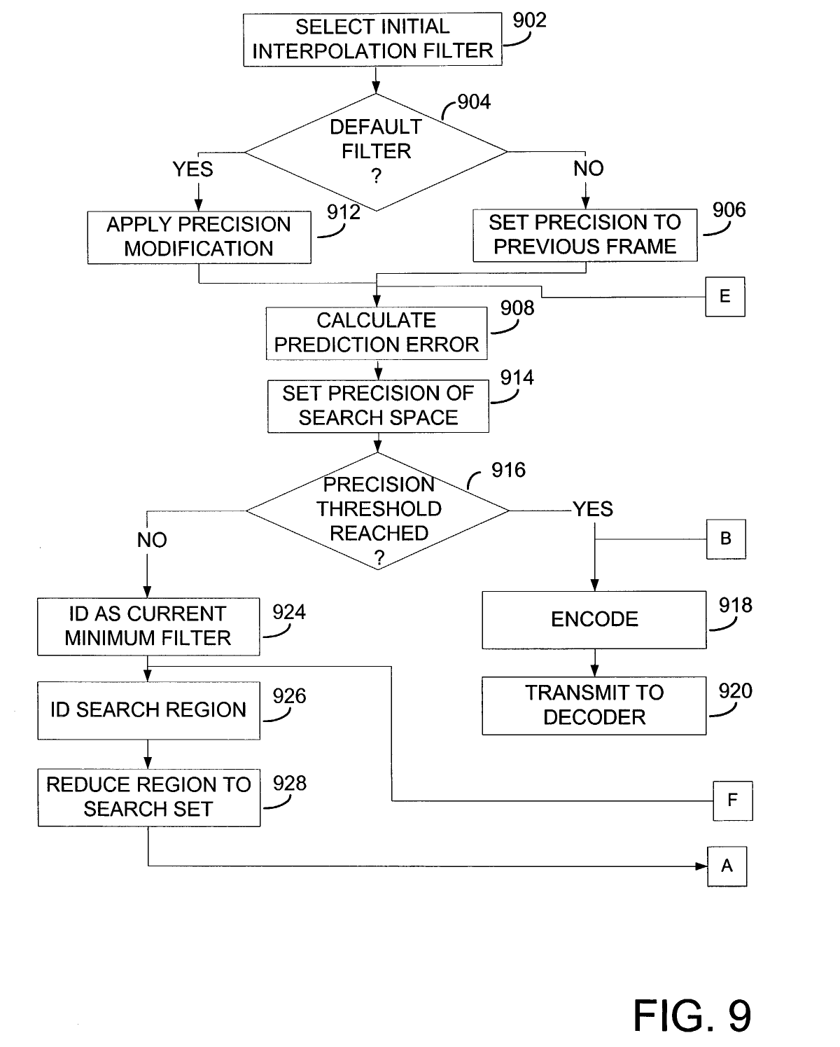

FIG. 9 is a process flow diagram illustrating one example of operation of the adaptive interpolation filter system 10 within the video codec 12 when a current frame s(t) is processed. The operation begins at block 902 when an initial interpolation filter is selected by the selection module 408. At block 904, it is determined if the initial filter is a default filter. If no, precision of the initial filter is set to the initial precision of the previously encoded frame at block 906. At block 908, the prediction error of the initial filter is determined with the motion compensation component 412. If at block 904, the initial filter is a default filter, a precision modification to the initial filter may be performed at block 912. The operation then proceeds to block 908 to determine the prediction error of the initial filter.

At block 914, the precision of the search space 404 may be set based on the precision of the initial filter. It is determined if the precision threshold has been exceeded at block 916. If yes, the motion vector, the final error prediction ε_{pred} and the interpolation filter for the current frame are encoded at block 918. At block 920, the encoded frame is transmitted to the decoder 16. If the precision threshold has not been exceed at block 916, the initial filter is identified as the current minimum interpolation filter at block 924.

Based on the position of the current minimum interpolation filter in the discrete search space, surrounding adjacently positioned interpolation filters may be included in a search region at block 926. At block 928, the subset component 420 may reduce the number of adjacently located filters in the search region to create a search set.

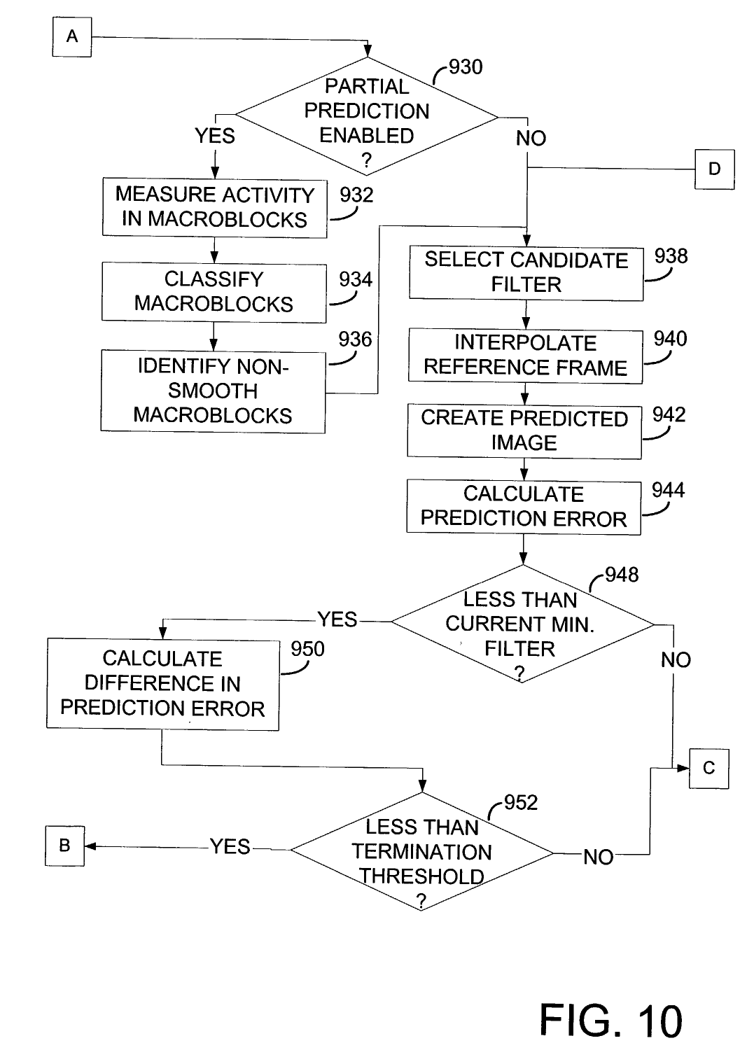

Referring now to FIG. 10, it is determined if partial prediction error is enabled at block 930. If yes, the activity of the macroblocks in the frame is measured at block 932. At block 934, the macroblocks below the activity threshold are classified as smooth macroblocks, and those above the activity threshold are classified as non-smooth macroblocks. The macroblocks identified as smooth macroblocks are eliminated from the search set and the non-smooth macroblocks are identified as blocks of the frame for which prediction error should be minimized at block 936.

At block 938 one of the candidate filters in the search set is selected. If at block 930, partial prediction error is not enabled, the operation proceeds directly to block 938 where one of the candidate filters in the search set is selected. At block 940, the reference frame s′(t−1) is interpolated with the selected candidate filter. The interpolated reference frame s′(t−1) is utilized with the motion vector \vec{m}(t) of the current frame s(t) by the motion compensation component 412 to create a predicted image ŝ(t) at block 942.

At block 944, the predicted image ŝ(t) is compared to the current frame s(t) and a prediction error ε_{pred} is calculated. It is determined if the prediction error ε_{pred} is less than the prediction error of the current minimum filter at block 948. If yes, the difference in prediction error is calculated at block 950. At block 952, it is determined if the difference is less than the termination threshold. If yes, the operation returns to block 918 of FIG. 9 to encode and transmit the frame.

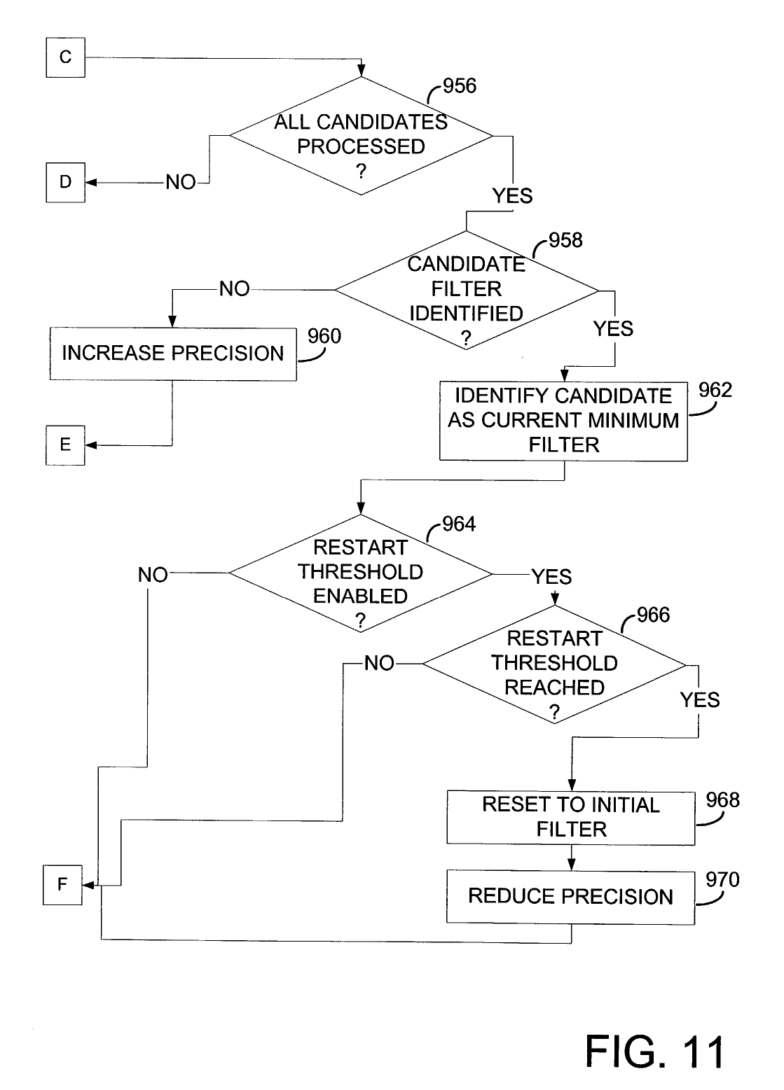

Referring to FIG. 11, if the difference is not less than the termination threshold, it is determined if all the candidate filters in the search set have been selected and a corresponding prediction error ε_{pred} determined at block 956. If at block 948 of FIG. 10, the prediction error ε_{pred} of the selected candidate filter is not less than the current minimum filter prediction error ε_{pred}, the operation proceeds directly to block 956 of FIG. 10. If all the candidate filters in the search set have not been selected at block 956 of FIG. 11, the operation returns to block 938 of FIG. 10 to select another candidate interpolation filter. If all the candidate filters in the search set have been processed at block 956, it is determined if a candidate filter a smaller prediction error ε_{pred} has been identified at block 958.

If no, the precision of the current minimum filter is raised at block 960 and the operation returns to block 908 of FIG. 9 to set the precision space and continue the search. If at block 958, a candidate filter was identified, the candidate filter is identified as the current minimum filter at block 962. At block 964, it is determined if the restart threshold is enabled. If no, the operation returns to block 926 of FIG. 9 and identifies the search region surrounding the new the current minimum filter. The operation then proceeds to again search for a minimum prediciton error. If the restart threshold is enabled, it is determined if the restart threshold has been reached at block 966. If the restart threshold has not been reached, the operation similarly returns to block 926 of FIG. 9 and identifies the search region. If the restart threshold has been reached, the current minimum filter is reset to the initial filter at block 968. At block 970, the precision of the identified initial filter and the search space is lowered and the operation again returns to block 926 of FIG. 9 to identify the search region.

The computational efficiency and performance of the previously described adaptive interpolation filter system 10 within the video encoder 12 may be exhibited by examples of performance testing. Performance testing of the adaptive interpolation filter system 10 with example implementations of the ten neighbor search technique and the six neighbor search technique has been completed. Utilizing the AIF design, the performance testing compared the performance of the heuristic search technique of the adaptive interpolation filter system 10 to the well-known variable metric search method and the downhill simplex search method. In other examples other implementations of the previously described adaptive interpolation filter system 10 may be performance tested against any other known search methods.

For the example performance testing, a 30 Hz CIF size Mobile sequence and a 30 Hz QCIF size Foreman sequence of frames, both with a length of 300 frames were utilized. The compression efficiency and the computational complexity were two issues examined during these examples of performance testing. The compression efficiency is reflected by Table 1 and Table 2 which describe the relations between the bitrate and the distortion, measured in terms of peak signal-to-noise ratio (PSNR).

Table 1 illustrates a comparison of the testing results of a peak signal noise ratio for various coding bitrates (PSNR/bitrate) for the Mobile sequence.

TABLE 1

| | QP = 16 | | QP = 21 | | QP = 26 | | QP = 31 | |
|---|---|---|---|---|---|---|---|---|
| | Rate | PSNR(Y) | Rate | PSNR(Y) | Rate | PSNR(Y) | Rate | PSNR(Y) |
| | (Kbps) | (dB) | (Kbps) | (dB) | (Kbps) | (dB) | (Kbps) | (dB) |
| Downhill | 1898.24 | 33.88 | 779.96 | 29.69 | 327.40 | 26.04 | 174.03 | 22.89 |
| Simplex | | | | | | | | |
| Method | | | | | | | | |
| Ten | 1909.63 | 33.88 | 784.06 | 29.67 | 328.24 | 26.00 | 174.17 | 22.84 |
| Neighbor | | | | | | | | |
| Method | | | | | | | | |
| Six | 1908.96 | 33.88 | 784.02 | 29.68 | 330.21 | 25.99 | 173.86 | 22.85 |
| Neighbor | | | | | | | | |
| Method | | | | | | | | |

Table 2 is a similar PSNR/bitrate comparison for the Foreman sequence.

TABLE 2

| | QP = 16 | | QP = 20 | | QP = 24 | | QP = 29 | |
|---|---|---|---|---|---|---|---|---|
| | Rate | PSNR(Y) | Rate | PSNR(Y) | Rate | PSNR(Y) | Rate | PSNR(Y) |
| | (Kbps) | (dB) | (Kbps) | (dB) | (Kbps) | (dB) | (Kbps) | (dB) |
| Downhill | 151.45 | 35.89 | 84.04 | 33.26 | 51.69 | 30.81 | 31.15 | 27.68 |
| Simplex | | | | | | | | |
| Method | | | | | | | | |
| Ten | 151.84 | 35.86 | 84.47 | 33.23 | 51.44 | 30.82 | 31.45 | 27.86 |
| Neighbor | | | | | | | | |
| Method | | | | | | | | |
| Six | 152.09 | 35.86 | 83.95 | 33.20 | 51.46 | 30.86 | 31.50 | 27.79 |
| Neighbor | | | | | | | | |
| Method | | | | | | | | |

In the performance testing examples, the computational complexity of the search methods is reflected by the rate (e.g. average time) used for coding a frame in a sequence. The variability of the rate with the quantization parameter (QP) characterizes the computational complexity experienced by the video codec. As indicated, in both Table 1 and Table 2, the rate utilizing the adaptive interpolation filter was typically substantially the same as the downhill simplex method at the various QPs. Accordingly, the adaptive interpolation filter system 10 may achieve coding efficiency equivalent to the state-of-the-art downhill simplex method, i.e., improving the coding efficiency at up to 1.0 dB of PSNR over TML-8 for ordinary video sequences.

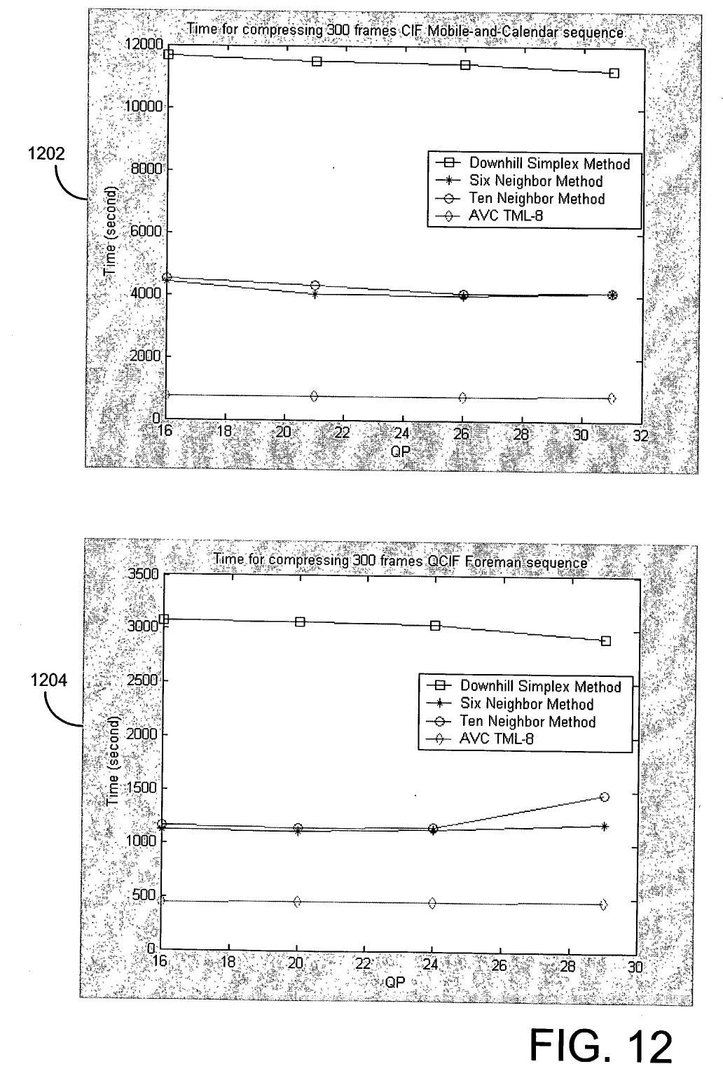

FIG. 12 is two graphs illustrating an example comparison of the average time to encode a frame with the downhill simplex method, the six neighbor technique, the ten neighbor technique and the AVC TML-8. In the example performance testing, the average time for encoding as a function of QP is shown for the different encoding methods. The AVC TML-8 search method was tested with a fixed interpolation filter of tap 6: W6 (Eq. 3) while the six neighbor search technique, the ten neighbor search technique and the downhill simplex method are applied to the AIF method. A first graph 1202 illustrates the average time to encode a frame with the different encoding methods for the Mobile sequence. A second graph 1204 similarly illustrates the average time to encode a frame for the Foreman sequence. As illustrated in the graphs 1202, 1204 a significant savings in average time during adaptive interpolation with the adaptive interpolation filter system 10 may be realized when compared to adaptive interpolation with the downhill simplex method. The significant savings in time may be achieved with substantially equivalent coding efficiency as the downhill simplex method. Accordingly, the adaptive interpolation filter system 10 is significantly more efficient in minimizing prediction error.

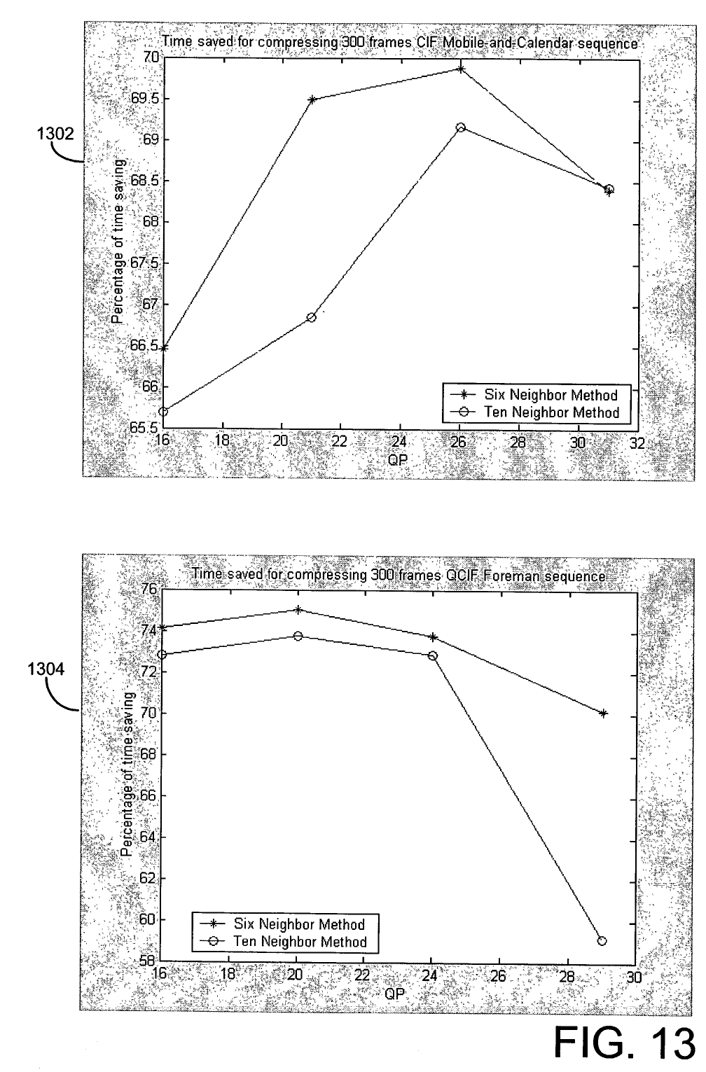

FIG. 13 is another set of graphs illustrating the percentage savings in average time for designing the AIF for a frame using the six neighbor search technique and the ten neighbor search technique. A first graph 1302 depicts the percentage time savings versus the downhill simplex method for compressing frames of the Mobile sequence with the ten neighbor and six neighbor search techniques. A second graph 1304 similarly illustrates time savings versus the downhill simplex method for compressing frames of the Foreman sequence with the ten neighbor and six neighbor search techniques. Compared to the downhill simplex method, use of the heuristic search technique may represent a savings of up to 75% in computing time for designing the AIF for each frame.

In the previous examples of performance testing, the tests were all based on AVC TML-8, more specifically; all experimental conditions were the same as TML-8 except the operation of the adaptive interpolation filter system 10. The software was TML-8 of AVC with a subsequent interpolation scheme. The first frame was coded as an I-picture; the remaining frames were coded as P-pictures. The precision of the motion vectors was ¼-pixel and one reference frame was used for motion compensation that was not rate distortion(RD)-optimized. The entropy coding method was universal variable length coding (VLC) (UVLC).

The initial filter used for the first search was the default filter with coefficients of tap 6:W6 (Eq. 3) for the first P-frame, and the interpolation filter optimized for the previous P-frame for other P-frames. The prediction error was the SATD divided by the number of pixels used in calculating the SATD.

With regard to the adaptive interpolation filter system 10, the initial filter was selected by the selection component 408 to be the default filter with the precision modification previously described with reference to Eq. 17. Alternatively, the default filter was selected as the current minimum filter of the previous frame and then normalized to adjust the precision. The initial filter was also used to set the initial precision for the search with the precision component 418. The final precision was determined with the precision threshold of deeper moves, which was set to three. The restart component 428 was enabled, and the restart threshold for the number of wider moves was set to three. The early termination component 430 was also enabled, where the prediction error threshold for the difference of two previous consecutive local minimums was set to 0.005. Further, the partial prediction error component 432 was enabled in the interpolation filter search. The activity measure for a macroblock was normalized by the pixel energy of the macroblock and the corresponding activity threshold was set at 0.002. Finally, the coefficients of the adaptive filters were coded in a predictive way, where the predictions are the adaptive filter coefficients of the previous frame.

The previously discussed heuristic search method of adaptive interpolation filters for motion compensated predictive coding of video signals may provide significant reductions in computational complexity and significant gains in efficiency. The design of the optimal interpolation filter is accomplished by a search of filters positioned within a discrete search space. The filters may be selectively applied during a series of trials to identify an optimal interpolation filter that best minimizes motion prediction error. The optimal filter obtained by the search may result in minimization of prediction error when a frame is coded, and therefore the compression performance is generally improved. For general video sequences, up to 1.0 dB PSNR improvement may be achieved when compared to a fixed filter interpolation. In addition, a computational time savings of up to 75% may be achieved when compared with the performance of previously known state-of-the-art methods using adaptive filters.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of obtaining an optimized interpolation filter for minimizing the predication error in a video codec, the method comprising:
a) selecting a current minimum filter located within a discrete three dimensional search space;
b) identifying a search region in the discrete three dimensional search space that includes a plurality of adjacently located filters;
c) interpolating a reference image signal with each of the adjacently located filters in the search region; and
d) identifying an adjacently located filter that results in minimization of prediction error.

2. The method of claim 1, further comprising:
e) increasing the precision of the current minimum filter and the identified search region; and
f) repeating a) through d) until a determined prediction error threshold is achieved.

3. The method of claim 1, further comprising:
e) identifying the adjacently located filter as the current minimum filter; and
repeating b) through d).

4. The method of claim 1, wherein b) comprises selecting adjacently located filters that are contiguous with the current minimum filter in the search region.

5. The method of claim 1, wherein b) comprises selecting adjacently located filters that are within a skew cube search set having the current minimum filter positioned at the center of the skew cube search set.

6. The method of claim 1, wherein b) comprises selecting up to six adjacently located filters that are contiguous with the current minimum filter.

7. The method of claim 1, wherein b) comprises selecting up to ten adjacently located filters that are contiguous with the current minimum filter.

8. A method of obtaining an optimized interpolation filter for minimizing the predication error in a video codec, the method comprising:
a) selecting a search set of filters within a three dimensional plurality of discrete filters as a function of a current minimum filter;
b) individually applying filters from the search set to a previous frame of an image signal to generate a predicted image;
c) calculating a prediction error between a current frame of an image signal and the predicted image; and
d) identifying one of the filters in the subset that minimizes the prediction error.

9. The method of claim 8, further comprising:
e) setting the identified filter as the current minimum filter; and
repeating a) through d).

10. The method of claim 9, further comprising:
f) terminating the method when the minimized prediction error identified in d) is within a determined prediction error threshold of the minimized prediction error previously identified in d).

11. The method of claim 8, wherein a) comprises selecting adjacently located filters with a gain that is substantially similar to the gain of the current minimum filter.

12. The method of claim 8, wherein a) comprises selecting a default filter for the current minimum filter.

13. The method of claim 8, wherein a) comprises selecting for the current minimum filter a current minimum filter of a previous frame that resulted in a minimized prediction error for the previous frame.

14. A method of obtaining an optimized interpolation filter for minimizing the predication error in a video codec, the method comprising:
a) providing a plurality of filters in a discrete search space;
b) searching for a filter that minimizes prediction error of a current frame;
c) limiting the search to a search set of candidate filters surrounding a current minimum filter; and
d) iteratively replacing the current minimum filter with one of the candidate filters that best minimizes prediction error; and
e) repeating c) and d) until an optimal filter is identified.

15. The method of claim 14, wherein d) comprises limiting prediction error determinations to non-smooth macroblocks within the current frame.

16. The method of claim 15, wherein d) further comprises measuring the activity level of an image in the macroblocks to identify non-smooth macroblocks.

17. The method of claim 14, wherein c) comprises shaping the search set in one of a cube and a skew cube.

18. The method of claim 14, wherein d) comprises increasing the precision of the current minimum filter and the discrete search space when further prediction error minimization ceases.

19. The method of claim 14, wherein d) comprises decreasing the precision of the current minimum filter and the discrete search space when the search expands beyond a determined number of search sets.

20. The method of claim 14, wherein a) comprises positioning the filters in a three dimensional grid that is the discrete search space.

21. A method of obtaining an optimized interpolation filter for minimizing the predication error in a video codec, the method comprising:
a) selecting a current minimum filter from a plurality of filters in a search space;
b) searching a search set of candidate filters proximate to the current minimum filter;
c) identifying a candidate filter within the search set that minimizes prediction error;
d) replacing the current minimum filter with the identified candidate filter and repeating b), c) and d) until further minimization of prediction error ceases; and
e) increasing the precision of the search space and repeating b), c), d) and e) until a determined prediction error threshold is reached.

22. The method of claim 21, wherein b) comprises searching up to 6 filters.

23. The method of claim 21, wherein b) comprises searching up to 10 filters.

24. The method of claim 21, wherein d) comprises reducing the precision of the search space and repeating a) through d) when a) through d) are repeated a determined number of times.

25. The method of claim 24, wherein d) further comprises:
resetting to an initial current minimum filter; and
reducing the precision of the initial current minimum filter.

26. The method of claim 21, wherein e) comprises increasing the precision of the current minimum filter.

27. The method of claim 21, wherein e) comprises modifying the filter coefficients of the filters.

28. An adaptive interpolation filter system for obtaining an optimized interpolation filter for minimizing the predication error in a video codec, the adaptive interpolation filter system comprising:
a memory device operable with a video codec;
a plurality of discrete filters disposed in a search space stored in the memory device;
instructions stored in the memory device to select a current minimum filter; and
instructions stored in the memory device to search those discrete filters in a search set surrounding the current minimum filter; wherein the search is operable to identify one of the filters as an optimal filter that minimizes prediction error.

29. The adaptive interpolation filter system of claim 25, wherein each of the filters includes up to six taps that are symmetric.

30. The adaptive interpolation filter system of claim 25, wherein the current minimum filter is initially a default filter with a precision modification.

31. The adaptive interpolation filter system of claim 25, wherein the current minimum filter is initially an optimal filter from a previous frame.

32. The adaptive interpolation filter system of claim 25, wherein the instructions to search include instructions to perform a wide search of the search region.

33. The adaptive interpolation filter system of claim 25, further comprising instructions stored in the memory device to increase the precision of the search space.

34. The adaptive interpolation filter system of claim 25, wherein the search space comprises a three dimensional grid of filters.

35. The adaptive interpolation filter system of claim 25, wherein the filters in the search set each include a gain that is substantially similar to a gain of the current minimum filter.

36. The adaptive interpolation filter system of claim 25, wherein each of the filters includes discrete filter coefficients in the form of a vector of integers.

37. The adaptive interpolation filter system of claim 25, wherein the search set is in the shape of a cube.

38. The adaptive interpolation filter system of claim 25, wherein the search set is in the shape of a skew cube.
